(19) United States
(12) Patent Application Publication
(10) Pub. No.: US 2024/0409679 A1
(43) Pub. Date: Dec. 12, 2024

(54) METHOD FOR PRODUCING A MIXTURE OF ALKOXYLATED POLYPHENOLS AND USE OF SAID MIXTURE

(71) Applicants: SOPREMA, STRASBOURG (FR); CENTRE NATIONAL DE LA RECHERCHE SCIENTIFIQUE - CNRS, PARIS (FR); UNIVERSITÉ DE STRASBOURG, STRASBOURG (FR)

(72) Inventors: Pierre Etienne BINDSCHEDLER, STRASBOURG (FR); Alexandru SARBU, SCHILTIGHEIM (FR); Antoine DUVAL, STRASBOURG (FR); Luc AVEROUS, WIWERSHEIM (FR)

(21) Appl. No.: 18/293,132

(22) PCT Filed: Jul. 29, 2022
(86) PCT No.: PCT/FR2022/051528

§ 371 Date: Jan. 29, 2024

(30) Foreign Application Priority Data
Jul. 30, 2021 (FR) FR2108354

(51) Int. Cl. C08G 18/64; C08G 65/331; C08J 9/14

(52) U.S. Cl. CPC C08G 18/6492; C08G 65/3317; C08J 9/141; C08J 2203/14; C08J 2375/08

(57) ABSTRACT

The present invention relates to a method for producing a mixture of alkoxylated polyphenols that can be used directly for producing different polyurethane materials, in particular polyurethane foams.

### CROSS-REFERENCE TO RELATED APPLICATIONS

This application is a National Stage Application of PCT/FR2022/051528 filed Jul. 29, 2022, which claims priority from French Patent Application No. 2108354 filed on Jul. 30, 2021. The priority of said PCT and French Patent Application are claimed. Each of the prior mentioned applications is hereby incorporated by reference herein in its entirety.

### FIELD OF THE INVENTION

The present disclosure relates to the field of alkoxylated polyphenols, in particular alkoxylated lignins. More specifically, the present invention relates to a method for manufacturing in one single step, a one-pot reaction and under mild conditions of a mixture of alkoxylated polyphenols. Afterwards, these alkoxylated polyphenols can be used directly to manufacture different polyurethane materials, in particular to manufacture polyurethane foams.

### BACKGROUND

The search for biosourced products that can be substituted with petroleum-derived products is a future strategy to reduce our dependence on fossil resources. Polyurethanes form a large family of polymers, demanding a lot of biosourced compounds. The building industry sector searches for biosourced and durable materials, in particular in the field of foams that can be used for thermal and/or acoustic insulation in the building. The uses of polyurethanes in this sector are essentially in the form of rigid polyurethane (RUP) and polyisocyanurate (PIR) foams.

The polyurethane materials (rigid and flexible foams, elastomers, adhesives, etc.) are based on the polyaddition reaction between a polyol, for example a polyphenol, and a polyisocyanate compound. A polyol should have specific properties to be used in the manufacture of polyurethane materials. For example, a polyol intended for the manufacture of a foam preferably has a viscosity at 25° C. comprised between 0.5 Pa·s and 100 Pa·s and a hydroxyl value comprised between 100 mg(KOH)·g⁻¹ and 700 mg(KOH)·g¹. Indeed, a polyol having such a viscosity is liquid and is easily mixed with the polyisocyanate compound and possible additives during the conventional manufacture of a polyurethane foam at room temperature. In addition, the hydroxyl value range indicated hereinabove allows obtaining a crosslinked three-dimensional network conferring on the foam, inter alia, its dimensional stability properties and its compressive strength.

Lignins and tannins are the most widespread biosourced polyphenols. Hence, they are of increasing interest in the manufacture of polyurethane materials. Hence, many chemical modifications of lignins and tannins have been studied to improve/modify their properties, in particular their viscosity and their hydroxyl value. One of these chemical modifications is etherification. It allows replacing the phenolic group OH of these polyphenols by alkylation. The etherification may be carried out according to two principles: epoxide ring opening or reaction with cyclic carbonates.

WO 2018/065728 describes a method for manufacturing alkoxylated polyphenols in two steps, based on the principle of epoxide ring opening. This method implements an agent selected from among propylene oxide, ethylene oxide, butylene oxide and mixtures thereof. These alkoxylating agents are particularly dangerous to handle because they are toxic, carcinogenic and very flammable, and even explosive. These alkoxylating agents also impose that the etherification step is carried out at high pressure because they have a boiling point lower than the temperature at which the reaction is implemented. A step of eliminating residual alkoxylating agents is also necessary because, for safety reasons, the product formed from alkoxylated polyphenols should not contain these dangerous products. Hence, there is a need to replace these alkoxylating agents and to simplify the implementation of the modified polyphenols.

US 2019/0144674 describes a method for manufacturing alkoxylated polyphenols comprising the following two steps:
a) dispersing lignin in a solvent to obtain a lignin dispersion,
b) bringing the lignin dispersion into contact with a cyclic carbonate such as ethylene carbonate to obtain an alkoxylated lignin dispersion.

The solvent implemented in this method is a compound comprising alcohol functions and having a boiling point comprised between 120° C. and 300° C. For example, this compound may consist of ethylene glycol, diethylene glycol, triethylene glycol, propylene glycol, dipropylene glycol, glycerol, dimethoxyethane or mixtures thereof.

This method requires a step c) of eliminating the solvent contained in the alkoxylated lignin dispersion to obtain an alkoxylated lignin having a viscosity suited for the manufacture of a foam. A viscosity adaptor compound may also be added into the alkoxylated lignin dispersion obtained by this method. Such an adapter is necessary to manufacture a polyurethane foam with the solid alkoxylated lignin of Example 1.

The application WO2019/099405 also describes a method for manufacturing alkoxylated polyphenols. This method also requires a step of eliminating the solvent, by distillation, to obtain an alkoxylated lignin having a viscosity suited for the manufacture of a foam.

Hence, the manufacture of a polyurethane foam by the alkoxylated lignins obtained by these processes is not simple.

Hence, there is a need for a method for manufacturing alkoxylated polyphenols which:
does not use propylene, ethylene and butylene oxides, and
produces alkoxylated polyphenols having physicochemical properties (chemical composition, viscosity, hydroxyl value, etc.) such that they can be used directly to manufacture polyurethane materials, i.e. they can be used in the manufacture of polyurethane materials, without an intermediate step such as a purification and/or an addition of a viscosity adapter compound being necessary.

### SUMMARY OF THE INVENTION

After extensive research, the Applicant has developed a method for manufacturing alkoxylated polyphenols which solves these problems.

Thus, an object of the present invention is a method for manufacturing a mixture of alkoxylated polyphenols comprising the following step:
(a) bringing at least one polyphenol and one cyclic carbonate ester into contact in the presence of a solvent, characterised in that the solvent has a molar mass comprised between 150 g·mol⁻¹ and 600 g·mol⁻¹, in particular between 175 g·mol⁻¹ and 600 g·mol⁻¹, in particular between 175 g·mol⁻¹ and 500 g·mol⁻¹, quite particularly between 200 g·mol⁻¹ and 400 g·mol⁻¹ and is selected from among a polyether, a polyester comprising OH groups at the end of the chain and mixtures thereof, in particular a polyether, and the cyclic carbonate ester-polyphenol mass ratio is comprised between 0.3:1 and 5:1, in particular between 0.5:1 and 3:1, quite particularly between 0.6:1 and 1.5:1.

Advantageously, the method of the invention allows producing a mixture of alkoxylated polyphenols in good safety conditions. Indeed, the method does not use toxic, carcinogenic and highly-flammable, and even explosive, reagents such as propylene, ethylene and butylene oxides. Similarly, it may be carried out at atmospheric pressure.

The method of the invention comprises the other advantage of being able to be carried out in one single reactor, which simplifies implementation thereof.

In addition, the properties of the mixture of alkoxylated polyphenols manufactured by the method of the invention, in particular a hydroxyl value comprised between 100 mg(KOH)·g⁻¹ and 1,000 mg(KOH)·g⁻¹ and a viscosity at 25° C. comprised between 0.5 Pa·s and 100 Pa·s, enable use thereof to manufacture different types of polyurethane materials, in particular polyurethane foams. Hence, the mixture of alkoxylated polyphenols can be used to manufacture polyurethane materials without the addition of a viscosity adapter compound or in other words without the addition of a viscosity modifying agent.

As indicated hereinabove, the mixture of alkoxylated polyphenols manufactured by the method of the invention is also devoid of reagents of the propylene oxide, ethylene and butylene type. More generally, it comprises a low content of residual reagents. Hence, the mixture of alkoxylated polyphenols may be used to manufacture polyurethane materials without an intermediate step of purification of said mixture being necessary.

Thus, advantageously, the method of the invention does not require a step of purifying the mixture of alkoxylated polyphenols or of adding a viscosity adapter compound into the mixture of alkoxylated polyphenols so that said mixture can be used to manufacture polyurethane materials, in particular a polyurethane foam.

Another object of the present invention is also a mixture of alkoxylated polyphenols obtainable by the manufacturing method as defined hereinabove.

Another object of the present invention is the use of a mixture of alkoxylated polyphenols obtainable by the manufacturing method according to the invention as defined hereinabove or of the mixture of alkoxylated polyphenols according to the invention as defined hereinabove to produce a polyurethane and/or polyisocyanurate material of different types, comprising for example a sealing product, an adhesive, a wood binder, a cast elastomer, a flexible or semi-flexible moulded part, a rigid structural composite, a polyurethane foam, a binder, a semi-flexible foam, a hose insulator, a cavity sealing module, or a microcellular foam.

Another object of the present invention consists of a method for manufacturing a polyurethane foam wherein the mixture of alkoxylated polyphenols produced during step (a) of the manufacturing method according to the invention as defined hereinabove or the mixture of alkoxylated polyphenols according to the invention as defined hereinabove is brought into contact with a polyisocyanate compound.

The mixture of alkoxylated polyphenols manufactured according to the method of the present invention or object of the present invention also has the advantage of being very reactive. Thus, the amount of catalyst that can be implemented in the method for manufacturing a polyurethane foam of the invention may advantageously be at least 60% less than the amount of catalyst implemented in a conventional method for manufacturing a polyurethane foam. In addition, the characteristic times of forming a foam from the mixture of alkoxylated polyphenols, in particular the processability time and the tack-free time, are less than the characteristic times of formation of a conventional foam.

In addition, the polyurethane foam obtained by the method for manufacturing a polyurethane foam of the invention has properties of the same order of magnitude as the properties of a conventional polyurethane foam. Hence, it may be advantageously used in an acoustic and/or thermal insulating product. Hence, the method object of the present invention allows effectively valorising polyphenols derived from renewable sources like lignin and tannins.

Another object of the present invention consists of a polyurethane foam obtainable by the method for manufacturing a polyurethane foam according to the invention as defined hereinabove.

Another object of the present invention consists of an acoustic and/or thermal insulating product comprising a foam according to the invention as defined hereinabove.

Another object of the present invention consists of a kit for manufacturing a polyurethane foam comprising:
a mixture of alkoxylated polyphenols obtainable by the method according to the invention as defined hereinabove or a mixture of alkoxylated polyphenols according to the invention as defined hereinabove, and
a polyisocyanate compound.

### DETAILED DESCRIPTION

According to an aspect of the invention, a method is provided for manufacturing a mixture of alkoxylated polyphenols comprising the following step:
(a) bringing at least one polyphenol and a cyclic carbonate ester into contact in the presence of a solvent,
   characterised in that
   the solvent has a molar mass comprised between 150 g·mol⁻¹ and 600 g·mol⁻¹, in particular between 175 g·mol⁻¹ and 600 g·mol⁻¹, in particular between 175 g·mol⁻¹ and 500 g·mol⁻¹, quite particularly between 200 g·mol⁻¹ and 400 g·mol⁻¹ and is selected from among a polyether, a polyester comprising OH groups at the end of the chain and mixtures thereof, in particular a polyether, and the cyclic carbonate ester:polyphenol mass ratio is comprised between 0.3:1 and 5:1, in particular between 0.5:1 and 3:1, quite particularly between 0.6:1 and 1.5:1.

The polyphenol implemented in the method according to the invention may be selected from among a lignin, a condensed tannin, a hydrolysable tannin and mixtures thereof, in particular a lignin.

Lignin is a biopolymer that binds cellulose and hemicellulose together to contribute in conferring structural rigidity on plants and also acts as a protective barrier against fungi. The lignin used in the method of the invention may be derived from resinous, hardwood, annual plants, agricultural plants or mixtures thereof. Typically, the lignin may be derived from hardwood, in particular from beech.

The lignin may also be selected from among a kraft lignin (also called “kraft process lignin” is a lignin obtained by the kraft paper process), a lignosulphonate (lignin obtained by the sulphite pulp process), a soda lignin (also called “soda process lignin” is a lignin obtained by the process that uses soda and anthraquinone to depolymerise the lignins), a lignin obtained from a process for preparing a paste in a solvent, a lignin derived from a biorefinery process, a pyrolytic lignin (lignin obtained by the pyrolysis process), a lignin by steam explosion (lignin obtained by use of high-pressure steam), an organosolv lignin and mixtures thereof, in particular selected from among an organosolv lignin, a kraft lignin, a soda lignin and mixtures thereof.

Kraft lignin is obtained in kraft paper pulp mills as a co-product of paper pulp. As an example of kraft lignin, it is possible to use, inter alia, Inndulin AT® commercialised by the company Ingevity, Amallin® commercialised by the company West Fraser, BioChoice® commercialised by the company Domtar, the kraft lignin commercialised by the company Fibria, or the Lineo® lignin commercialised by the company Stora Enso.

Lignosulphonate structurally differs from kraft lignin by the addition of generally salified sulphonic functions, which ensures better solubility thereof in water. Examples of lignosulfonate are lignosulphonate of the Borresperse®, Ultrazine®, Ufoxane® or Vanisperse® type.

Organosolv lignin is obtained by chemical attach of woody plants, such as cereal or wood straw, by means of various solvents, such as ethanol, acetone, formic acid and/or acetic acid, sometimes in the presence of an acid catalyst. Among the different sources of organosolv lignin, mention may be made of Biolignin® commercialised by the company CIMV, the organosolv lignin commercialised by the company Fibria® and the organosolv lignin produced by the Fabiola® process.

According to a particular embodiment, the lignin is a beechwood organosolv lignin, a kraft lignin or a soda lignin, more particularly a beechwood organosolv lignin produced by the Fabiola® process.

In the context of the present invention, “molar mass” refers to the number-average molar mass. As indicated hereinabove, the solvent implemented in the method of the invention has a molar mass comprised between 150 g·mol⁻¹ and 600 g·mol⁻¹, in particular between 175 g·mol⁻¹ and 600 g·mol⁻¹, in particular between 175 g·mol⁻¹ and 500 g·mol⁻¹, quite particularly between 200 g·mol⁻¹ and 400 g mol⁻¹.

For the same polyphenol:solvent mass ratio, if the solvent has a molar mass lower than 150 g·mol⁻¹, in particular lower than 175 g·mol⁻¹, then the hydroxyl value of the mixture of alkoxylated polyphenols is too high for said mixture to be used for the manufacture of polyurethane materials, in particular rigid polyurethane foams, having satisfactory properties. Indeed, these materials, in particular these foams, are too friable.

If the solvent has a molar mass higher than 600 g·mol⁻¹ then the hydroxyl value of the mixture of alkoxylated polyphenols is too low for said mixture to be used for the manufacture of polyurethane materials, in particular rigid polyurethane foams, having satisfactory properties. Indeed, these materials are insufficiently crosslinked and therefore too soft. In addition, the viscosity of the mixture of alkoxylated polyphenols is so high that it cannot be used for the manufacture of polyurethane materials, in particular polyurethane foams, without using a viscosity modifying agent.

In the context of the present invention, “polyether” refers to a polymer whose macromolecular skeleton contains repeating units containing an ether group. It is also possible to talk about polyether polyols. The macromolecular chains of the polyethers useful in the present invention (advantageously) have hydroxyl functions (—OH) as terminal groups. The polyethers may be aliphatic or aromatic, more preferably the polyethers useful in the present invention are aliphatic.

Typically, the polyether may be selected from among poly(oxyalkylene glycol) like, for example, polybutylene glycol, polyethylene glycol, polypropylene glycol, polytrimethylene ether glycol, block copolymers, alternating or statistical obtained from these monomers and mixtures thereof, in particular a poly(oxyalkylene glycol), more particularly polyethylene glycol.

In the context of the present invention, “polyester” refers to a polymer wherein the repeating units of the main chain contain the ester function and which does not have a boiling point. The polyester useful in the present invention also has hydroxyl functions (—OH) as terminal groups. It is also possible to talk about polyester polyol.

According to another particular embodiment, the solvent has a boiling temperature higher than 300° C., or ha no boiling temperature.

This embodiment allows avoiding various problems associated with the use of volatile solvents, having in particular a boiling point lower than 300° C.
For example, this embodiment allows avoiding the problems of toxicity and of hazard associated with the presence of solvent vapours on the site.

According to one embodiment, the polyphenol:solvent mass ratio is comprised between 0.1:1 and 1:1, in particular is comprised between 0.2:1 and 0.5:1, more particularly is comprised between 0.25:1 and 0.35:1.

According to a particular embodiment, the cyclic carbonate ester:polyphenol mass ratio is comprised between 0.6:1 and 1.5:1, and the polyphenol:solvent mass ratio is comprised between 0.25:1 and 0.35:1.

The cyclic carbonate ester useful in the present invention as an alkoxylating agent may be selected from among butylene carbonate, ethylene carbonate, propylene carbonate, glycerol carbonate and mixtures thereof, in particular ethylene carbonate and propylene carbonate and mixtures thereof, quite particularly ethylene carbonate.

A catalyst may be implemented in step (a). This allows accelerating the kinetics of the reactions implemented in step (a).

The use of a catalyst is particularly suitable when the lignin is not basic enough for the mixture of alkoxylated polyphenols to be manufactured by the method of the present invention.

Thus, according to a particular embodiment of the present invention, the method for manufacturing a mixture of alkoxylated polyphenols comprises the following step:
(a) bringing at least one polyphenol, a cyclic carbonate ester, a catalyst into contact in the presence of a solvent, characterised in that the solvent has a molar mass comprised between 150 g·mol⁻¹ and 600 g·mol⁻¹, in particular between 175 g·mol⁻¹ and 600 g·mol⁻¹, in particular between 175 g·mol⁻¹ and 500 g mol⁻¹, quite particularly between 200 g·mol⁻¹ and 400 g·mol⁻¹ and is selected from among a polyether, a polyester comprising OH groups at the end of the chain and mixtures thereof, in particular a polyether, and
   the cyclic carbonate ester:polyphenol mass ratio is comprised between 0.3:1 and 5:1, in particular between 0.5:1 and 3:1, quite particularly between 0.6:1 and 1.5:1.

For example, the catalyst may be a basic compound selected from among alkali metal hydroxides, alkaline-earth metal hydroxides, alkali metal alcoholates, alkali metal carbonates. In particular, the catalyst may be selected from among sodium hydroxide, sodium carbonate, sodium hydrogen carbonate, potassium hydroxide, potassium carbonate, potassium hydrogen carbonate, lithium hydroxide, calcium hydroxide, calcium carbonate, calcium hydrogen carbonate and mixtures thereof, more particularly potassium carbonate.

Typically, the catalyst:cyclic carbonate ester ratio may be comprised between 0.001:1 and 0.5:1, in particular between 0.025:1 and 0.3:1, quite particularly between 0.05:1 and 0.2:1.

Step (a) may be carried out at a temperature comprised between 80° C. and 200° C., in particular between 100° C. and 150° C., more particularly between 12° and 140° C., for example 130° C.

Step (a) may be carried out at a pressure lower than 1.5 bar, in particular carried out at atmospheric pressure.

Step (a) may be carried out under an inert atmosphere, in particular under an inert gas stream. Advantageously, the inert atmosphere allows avoiding parasitic reactions such as oxidation and the inert gas stream allows conveying the gaseous products formed during step a) such as CO₂. Any inert gas such as argon, nitrogen or mixtures thereof may be used.

Advantageously, step (a) may therefore be carried out under mild operating conditions.

Moreover, the method may be implemented in batches, semi-continuously or continuously.

Step (a) of the method of the invention may be followed by conventional chemical analysis methods, like, for example, NMR.

According to a particular embodiment, step (a) comprises the following sub-steps:
(a1) mixing the at least one polyphenol and the solvent in a reactor to obtain a mixture,
(a2) adding the cyclic carbonate ester into the mixture, and
(a3) optionally adding the catalyst into the mixture obtained in step (a2), and
(a4) mixing the mixture obtained in step (a2) or in step (a3) to manufacture the mixture of alkoxylated polyphenols.

The sub-steps (a1), (a2) and (a3) may be carried out at room temperature.

Step (a4) may be carried out under the inert atmosphere described hereinabove and/or in the temperature range described hereinabove.

According to a particular embodiment, the polyphenol is a lignin, the cyclic carbonate ester is ethylene carbonate, the solvent is a polyethylene glycol with a molar mass comprised between 200 g·mol⁻¹ and 400 g mol⁻¹ and the catalyst is potassium carbonate.

According to a particular embodiment, the cyclic carbonate ester:polyphenol mass ratio is comprised between 0.6:1 and 1.5:1, the polyphenol:solvent mass ratio may be comprised between 0.25:1 and 0.35:1, and the catalyst:cyclic carbonate ester molar ratio is comprised between 0.05:1 and 0.2:1.

According to a quite particular embodiment:
the polyphenol is a lignin, the cyclic carbonate ester is ethylene carbonate, the solvent is a polyethylene glycol with a molar mass comprised between 200 g·mol⁻¹ and 400 g mol⁻¹ and the catalyst is potassium carbonate,
the cyclic carbonate ester:polyphenol mass ratio is comprised between 0.6:1 and 1.5:1,
the polyphenol:solvent mass ratio may be comprised between 0.25:1 and 0.35:1, and
the catalyst:cyclic carbonate ester molar ratio is comprised between 0.05:1 and 0.2:1,

The mixture of alkoxylated polyphenols manufactured by the method of the invention has a hydroxyl value comprised between 100 mg(KOH)·g⁻¹ and 1,000 mg(KOH)·g⁻¹ and a viscosity, at 25° C., comprised between 0.5 Pa·s and 100 Pa·s.

In the context of the present invention, “hydroxyl value” refers to the amount of potassium hydroxide in milligrams necessary to neutralise the acetic acid absorbed upon acetylation of one gram of alkoxylated polyphenols containing free hydroxyl groups. In particular, the mixture of alkoxylated polyphenols may have a value between 150 mg(KOH)·g⁻¹ and 800 mg(KOH)·g⁻¹, more particularly between 200 mg(KOH)·g⁻¹ and 650 mg(KOH)·g⁻¹.

The method of the invention allows obtaining a mixture of alkoxylated polyphenols, whose hydroxyl value is within a wider range than the ranges usually reported for lignin-based polyols prepared by oxypropylation. Advantageously, this allows using the mixture of alkoxylated polyphenols for a wide range of applications, such as rigid or flexible polyurethane foams, or polyisocyanurate foams.

In addition to the hydroxyl value range of the mixture of alkoxylated polyphenols manufactured by the method of the invention is suited for the synthesis of polyurethane materials, in particular of polyurethane foam. Indeed, the hydroxyl value range that a rigid polyurethane foam manufacturer pursues extends from 100 mg(KOH)·g⁻¹ to 700 mg(KOH)·g¹. In the case of a RUP-type foam, the hydroxyl value range allowing obtaining a crosslinked three-dimensional network is comprised between 300 mg(KOH)·g⁻¹ and 700 mg(KOH)·g⁻¹ while for a PIR-type foam, the hydroxyl value range should be comprised between 100 mg(KOH)·g⁻¹ and 500 mg(KOH)·g¹. In turn, the mixture of alkoxylated polyphenols having a high hydroxyl value, i.e. up to 1,000 mg(KOH)·g⁻¹ may be used as a mixture with a polyol to manufacture, for example, coatings or varnishes made of polyurethane. The mixture of alkoxylated polyphenols having a viscosity at 25° between 0.5 Pa·s and 100 Pa·s is liquid and is easily mixed with the polyisocyanate compound and possible additives during the conventional manufacture of a polyurethane foam at room temperature.

In the context of the present invention, “viscosity” refers to the Brookfield viscosity and/or the viscosity measured by a cone-plane viscometer of the mixture of alkoxylated polyphenols at 25° C. In particular, the mixture of alkoxylated polyphenols may have a viscosity comprised between 1.5 Pa·s and 10 Pa·s, quite particularly comprised between 2 Pa·s and 8 Pa·s

The method of the invention also allows obtaining a mixture of alkoxylated polyphenols whose viscosity is adapted to the synthesis of polyurethane materials, in a polyurethane foam. Indeed, the mixture of polyphenols is liquid at 25° C. and is easily mixed with the polyisocyanate compound and with possible additives during the conventional manufacture of a polyurethane foam at room temperature.

In addition, without the intention to be bound by any theory, the Inventors agree that the combined use of the cyclic carbonate ester and of the solvent with a molar mass higher than 150 g/mol, in particular ethylene carbonate and polyethylene glycol comprising a molar mass comprised between 200 g/mol and 400 g/mol, implemented in the method of the invention enables the manufacture of mixtures of alkoxylated polyphenols with varied properties. More particularly, by increasing or decreasing the molar mass of the solvent, it is easy to adapt the hydroxyl value and the viscosity of said mixture according to its subsequent use. For example, by adapting the molar mass of the solvent, it is possible to obtain a mixture of alkoxylated polyphenols whose hydroxyl value and viscosity are suitable for manufacturing rigid or flexible polyurethane foams, elastomers or adhesives.

Thus, it is not necessary to eliminate the solvent contained in the mixture of alkoxylated polyphenols obtained in particular upon completion of step a) of the method of the invention and/or to add a viscosity adapter compound, such as a polyether polyol, a polyester polyol, a Mannich-based polyol, into the mixture of alkoxylated polyphenols as described in US 2019/0144674 and in WO 2019/099405, because the viscosity of the mixture of alkoxylated polyphenols obtained in particular upon completion of step a) of the method of the invention is within a range enabling the manufacture of polyurethane materials.

In other words, the particular conditions implemented in the method according to the present invention allow obtaining, upon completion of step a), a product with a viscosity and a hydroxyl value compatible with a use in the manufacture of polyurethane materials. Unlike the methods of the prior art, it is not necessary to purify, in particular by distillation, the product obtained upon completion of step a).

As mentioned hereinabove, the cyclic carbonate ester:polyphenol mass ratio is comprised between 0.3:1 and 5:1, in particular between 0.5:1 and 3:1, quite particularly between 0.6:1 and 1.5:1. Hence, the implemented cyclic carbonate ester content is low. Nevertheless, it is possible that the cyclic carbonate ester has not totally reacted. Thus, the mixture of alkoxylated polyphenols obtained according to the method object of the present invention may comprise cyclic carbonate ester that has not reacted, in other words the residual cyclic carbonate ester. Nonetheless, these residual cyclic carbonate ester contents are very low. Indeed, the residual cyclic carbonate ester content in the mixture may be comprised between 1% and 5%, in particular comprised between 2.5% and 4.5% with respect to the mass of the mixture of alkoxylated polyphenols.

Since these residual cyclic carbonate ester contents are very low, it is not necessary to purify the mixture of alkoxylated polyphenols to eliminate the residual cyclic carbonate ester before the use of said mixture of alkoxylated polyphenols. It may even be advantageous to preserve the residual cyclic carbonate ester in the mixture of alkoxylated polyphenols. Indeed, the Inventors have noticed that the cyclic carbonate ester, in particular ethylene carbonate, may be used as a chemical blowing agent during the manufacture of a polyurethane foam.

Thus, according to a particular embodiment, the method according to the invention does not comprise, after step (a), a step of purifying the mixture of alkoxylated polyphenols and/or a step of adding a viscosity adapter compound to the mixture of alkoxylated polyphenols, in particular a step of purifying the mixture of alkoxylated polyphenols.

In the context of the present invention, “purification step” refers to any step conventionally used by a person skilled in the art to completely or partially eliminate the solvent and/or the residual cyclic carbonate ester of the mixture of alkoxylated polyphenols, like for example a step of distillation or evaporation under vacuum.

In addition, the reactivity of the mixture of alkoxylated polyphenols obtained by the method object of the present invention is very high. This allows advantageously reducing the amount of catalyst required for manufacturing a polyurethane material of at least 60%, and possibly up to 95%.

Hence, the mixture of alkoxylated polyphenols manufactured by the method of the invention has properties (chemical composition, viscosity, hydroxyl value, reactivity, . . . ) such that it is suited to be used directly in the manufacture of polyurethane materials, in particular a polyurethane foam.

Thus, another object of the present invention is a mixture of alkoxylated polyphenols obtainable by the method according to the invention as defined hereinabove.

Without the intention to be bound by any theory, the Inventors agree that, during step (a) of the method of the invention, the polyphenol can react with the cyclic carbonate ester and/or with the solvent according to the different next reactions (for clarity, yet without limitation, the polyphenol is lignin, the cyclic carbonate ester is ethylene carbonate and the solvent is polyethylene glycol (PEG) in the following reactions):

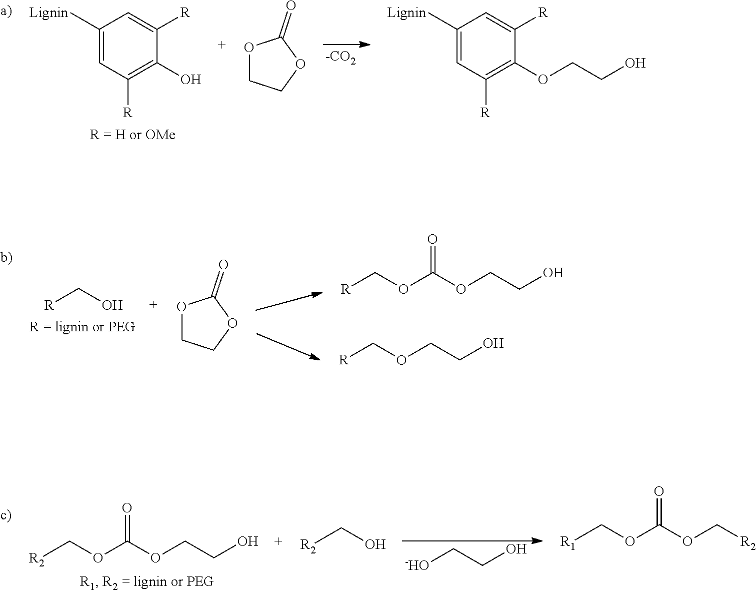

Thus, the alkoxylated polyphenols of the mixture may comprise at least one unit selected from among:

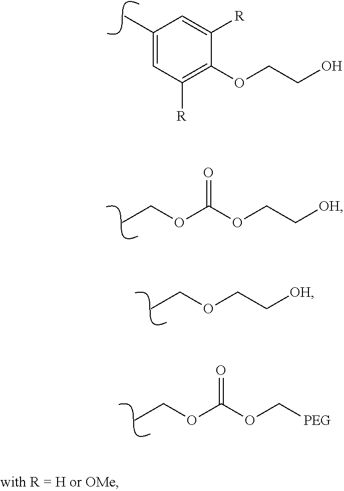

and mixtures thereof, in particular mixtures thereof.

The Inventors also agree that the reactivity of the solvent, in particular polyethylene glycol, with the cyclic carbonate ester is low so that the solvent does not hinder the reaction of the cyclic carbonate ester with the polyphenol.

According to one embodiment, the mixture of alkoxylated polyphenols, object of the present invention, has a hydroxyl value comprised between 100 mg(KOH)·g⁻¹ and 1,000 mg(KOH)·g⁻¹ and a viscosity, at 25° C., comprised between 0.5 Pa·s and 100 Pa·s.

In particular, the mixture of alkoxylated polyphenols may have a value between 150 mg(KOH)·g⁻¹ and 800 mg(KOH)·g⁻¹, more particularly between 200 mg(KOH)·g⁻¹ and 650 mg(KOH)·g⁻¹, even more particularly between 300 mg(KOH)·g⁻¹ and 500 mg(KOH)·g⁻¹.

In particular, the viscosity of the mixture of alkoxylated polyphenols may be comprised between 1.5 Pa·s and 10 Pa·s, quite particularly between 2 Pa·s and 8 Pa·s, in particular between 2.5 Pa·s and 8.5 Pa·s.

According to a particular embodiment, the mixture of alkoxylated polyphenols has a hydroxyl value comprised between 150 mg(KOH)·g⁻¹ and 600 mg(KOH)·g⁻¹ and a viscosity comprised between 2.5 Pa·s and 10 Pa·s.

According to a particular embodiment, the mixture of alkoxylated polyphenols has a hydroxyl value comprised between 300 mg(KOH)·g⁻¹ and 500 mg(KOH)·g⁻¹ and a viscosity comprised between 2.5 Pa·s and 8.5 Pa·s.

As explained hereinabove, the mixture of alkoxylated polyphenols of the present invention advantageously has properties (chemical composition, viscosity, hydroxyl value, reactivity) such that it is particularly suited to be used directly in the manufacture of polyurethane materials, in particular in the manufacture of a polyurethane foam.

Another object of the invention is the use of the mixture of alkoxylated polyphenols obtainable by the manufacturing method according to the invention as defined hereinabove or of the mixture of alkoxylated polyphenols according to the invention as defined hereinabove to produce a polyurethane and/or polyisocyanurate material of different types, like for example a sealing product, an adhesive, a wood binder, a cast elastomer, a flexible or semi-flexible moulded part, a rigid structural composite, a polyurethane foam, a binder, a semi-flexible foam, a hose insulator, a cavity sealing module, or a microcellular foam.

Another object of the invention is also a method for manufacturing a polyurethane foam in which the mixture of alkoxylated polyphenols produced during step (a) of the manufacturing method according to the invention as defined hereinabove or the mixture of alkoxylated polyphenols according to the invention as defined hereinabove is brought into contact with a polyisocyanate compound.

In the context of the present invention, the term “foam” as used, for example, in the expression “polyurethane foam”, refers to a compound with an expanded-type three-dimensional cellular structure. Said foam may be rigid or flexible, with open or closed cells. Rigid polyurethane foams are so-called rigid polyurethane (RPU).

In the context of the present invention, “closed-cell foam” refers to a foam whose cellular structure includes walls between each cell forming a set of joined and distinct cells allowing trapping an expansion gas. A foam is qualified as closed-cell foam when it has a maximum of 10% of open cells. Typically, the closed-cell foams are predominantly rigid foams.

In the context of the present invention, “open-cell foam” refers to a foam whose cellular structure consists of a continuous cellular matrix with open walls between the cells not allowing trapping of a gas expansion. Such a foam allows creating percolation paths within its cellular matrix. Typically, the open-cell foams predominantly consist of flexible foams.

Typically, the polyisocyanate compound may be selected from among m-phenylene diisocyanate, toluene 2,4-diisocyanate, toluene 2,6-diisocyanate, hexamethylene 1,6-diisocyanate, tetramethylene 1,4-diisocyanate, cyclohexane 1,4-diisocyanate, hexahydrotoluene diisocyanate, naphthylene 1,5-diisocyanate, methoxyphenyl-2,4-diisocyanate, diphenylmethane 4,4′-diisocyanate, biphenylene 4,4′-diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, polymethylene polyphenylisocyanate, polymeric diphenylmethane diisocyanate, isophorone diisocyanate, toluene 2,4,6-triisocyanate, 4,4′-dimethyldiphenylmethane-2,2,5,5′-tetraisocyanate and mixtures thereof, in particular from among toluene 2,4-diisocyanate, toluene 2,6-diisocyanate, hexamethylene 1,6-diisocyanate, diphenylmethane 4,4′-diisocyanate, a polymethylene polyphenylisocyanate, polymeric diphenylmethane diisocyanate, isophorone diisocyanate and mixtures thereof, more particularly from among diphenylmethane 4,4′-diisocyanate, a polymethylene polyphenylisocyanate, polymeric diphenylmethane diisocyanate, toluene 2,4-diisocyanate, toluene 2,6-diisocyanate and mixtures thereof, still more particularly polymeric diphenylmethane diisocyanate.

Advantageously, the polymeric diphenylmethane diisocyanate is adapted to the production of a polyurethane foam.

Typically, the alkoxylated polyphenols:polyisocyanate compound mass ratio may be comprised between 1:100 and 45:100, in particular between 3:100 and 40:100, quite particularly between 5:100 and 35:100.

The mixture of alkoxylated polyphenols may be used alone in the method for manufacturing a polyurethane foam according to the invention.

Alternatively, the mixture of alkoxylated polyphenols may be used mixed with another type of polyol, for example with a polyol conventionally used for the manufacture of a petroleum-derived polyurethane foam selected from among alkoxylated glycerol, alkoxylated sorbitol, alkoxylated diethyl triamine, alkoxylated sucrose and mixtures thereof. Advantageously, the mixture of alkoxylated polyphenols is used mixed with another type of polyol, for example with a polyol conventionally used for the manufacture of a petroleum-derived polyurethane foam selected from among alkoxylated glycerol, alkoxylated sorbitol, alkoxylated diethyl triamine, alkoxylated sucrose and mixtures thereof.

Typically, the polyol compound:polyisocyanate compound ratio may be comprised between 40:100 and 75:100, in particular comprised between 45:100 and 70:100, quite particularly from 50:100 to 66:100. In this ratio, the term “polyols” refers to the mixture of alkoxylated polyphenols and the other type of polyol.

A catalyst may be used to accelerate the kinetics of the reaction between the mixture of alkoxylated polyphenols and the polyisocyanate compound during the contacting step of the method for manufacturing a polyurethane foam.

Thus, according to one embodiment, the contacting step of the method for manufacturing a polyurethane foam is carried out in the presence of a catalyst.

The amount of catalyst implemented in the method for manufacturing a polyurethane foam of the invention depends on the compounds implemented in said method. A person skilled in the art will know how to adapt this amount.

As mentioned hereinabove, the reactivity of the mixture of alkoxylated polyphenols object of the present invention being very high, the amount of catalyst implemented in the method of the invention may advantageously be at least 60% and up to 95% lower than the amount of catalyst implemented in a conventional method for manufacturing a polyurethane foam.

Typically, the catalyst may be selected from among tertiary amines, such as triethylamine, tributylamine, N-methylmorpholine, N-ethylmorpholine, N,N,N′,N′-tetramethylethylenediamine, pentamethyldiethylenetriamine and the like, 1,4-diazabicyclo(2.2.2)octane, N-methyl-N′-dimethyl-aminoethylpiperazine, bis-(dimethylaminoalkyl)piperazines, N,N-dimethylbenzylamine, N,N-dimethylcyclohexylamine, N,N-diethyl-benzylamine, bis-(N,N-diethylaminoethyl) adipate, N,N,N′,N-tetramethyl-1,3-butanediannin, N,N-dimethyl-1,3-phenylethylamine, 1,2-dimethylimidazole, 2-methylimidazole, monocyclic and bicyclic amines and bis-(dialkylamino)alkyl ethers, such as 2,2-bis-(dimethylaminoethyl) ether, tin derivatives (such as dibutyltin dilaurate), ammonium salts (such as, 2,2-dimethylpropanoate N,N,N-trimethyl methanaminium), alkali metal carboxylates (such as potassium 2-ethylhexanoate, triazines (such as 1,3,5-Tris(3-(dimethylamino)propyl)hexahydro-1,3,5-triazine) and mixtures thereof in particular from among triethylamine, tributylamine, N-methylmorpholine, N-ethylmorpholine, N,N,N′,N′-tetramethylethylenediamine, pentamethyldiethylenetriamine N,N-dimethylbenzylamine, N,N-dimethylcyclohexylamine, N,N-diethyl-benzylamine and mixtures thereof.

In order to modify and/or improve the properties of the polyurethane foam, an additive known to a person skilled in the art may be added during the contacting step. Typically, this additive may be selected from among a surfactant, a flame-retardant agent, a blowing agent, an antioxidant, a release agent, an anti-hydrolysis agent, a biocide, an anti-UV agent and mixtures thereof, in particular selected from among a surfactant, a flame-retardant agent, a blowing agent and mixtures thereof, more particularly a mixture of a surfactant and a blowing agent.

In the context of the present invention, “flame-retardant agent (also called flame retardant)” refers to a compound having the property of reducing or preventing the combustion or heat-up of the materials it impregnates or covers. For example, the flame-retardant agent may be antimony, graphite, a silicate, boron, a nitrogen, halogenated or phosphorus compound such as tris (1-chloro-2-propyl) phosphate (TCPP), triethylene phosphate (TEP), a triaryl phosphate ester, an ammonium polyphosphate, red phosphorus, trishalogenaryl or mixtures thereof.

In the context of the present invention, “blowing agent” refers to a compound inducing, through a chemical and/or physical action, an expansion of a composition during a foaming step. Typically, the chemical blowing agent is selected from among water, formic acid, phthalic anhydride and acetic acid. The physical blowing agent may be selected from among pentane and pentane isomers, hydrocarbons, hydrofluorocarbons, hydrochlorofluoroolefins, hydrofluoroolefins (HFOs), ethers and mixtures thereof. Mention may be made of methylal as an example of an ether-type blowing agent. According to the invention, a preferred chemical and physical blowing agent mixture is for example a water/pentane isomer or formic acid/pentane isomer or water/hydrofluoroolefins or pentane isomer/methylal/water or water/methylal mixture.

In the context of the present invention, “surfactant” refers to an agent allowing for physical stability of the polymer matrix during the progress of the reactions, in particular by the anti-coalescent stabilisation during the polymerisation. Typically, the surfactant is selected from among any one of the silicone glycol copolymers (for example Dabco® DC198 or DC193 commercialised by Air Products), a silicone glycol non-hydrolysable copolymer (for example DC5000 by Air Products), a polyalkylene siloxane copolymer (for example Niax* L-6164 by Momentive), a polyoxyalkylene-polyoxyalkylene copolymer (for example Niax* L-5348 by Momentive), a polyetherpolysiloxane copolymer (for example Tegostab® B8870 or Tegostab® B1048 by Evonik), a polydimethylsiloxane polyether copolymer (for example Tegostab® B8526 by Evonik), a polyethersiloxane (for example Tegostab® B8951 by Evonik), a modified polyether-polysiloxane copolymer (for example Tegostab® B8871 by Evonik), a polyoxyalkylene block polysiloxane copolymer (for example Tegostab® BF 2370 by Evonik) and derivatives thereof or mixtures thereof, in particular from a modified polyether-polysiloxane copolymer.

Typically, the antioxidant may be an agent for neutralising the ends of chains at the origin of the depolymerisation and/or an agent for neutralising the ends of co-monomer chains capable of stopping the propagation of depolymerisation.

The release agent may be a talc, a paraffin solution, silicone or mixtures thereof.

the anti-UV agent may be titanium oxide, triazine, benzotriazole or mixtures thereof.

According to one embodiment, the additive is a mixture of a modified polyether-polysiloxane copolymer surfactant, tris (1-chloro-2-propyl) phosphate (TCPP), triethylene phosphate (TEP), a triaryl phosphate ester, an ammonium polyphosphate and red phosphorus.

according to another aspect, the present invention relates to a polyurethane foam obtainable by the method for manufacturing a polyurethane foam according to the invention as defined hereinabove.

Advantageously, the polyurethane foam manufactured from polyphenols derived from renewable sources like lignin or tannins by the method of the invention has properties, in particular a density, a thermal conductivity and a fire resistance, of the same order of magnitude as a conventional polyurethane foam manufactured with petroleum-derived products.

Thus, according to another aspect, an acoustic and/or thermal insulating product is provided comprising a foam according to the invention as defined hereinabove.

For example, the acoustic and/or thermal insulating product may be in the form of a panel or a foam block.

By “panel”, it should be understood an object having approximately a rectangular parallelepiped shape having relatively smooth surfaces and the following dimensions of 0.1 m² to 50 m² of surface area for a thickness of 10 mm to 1,000 mm, preferably, from 0.2 m² to 20 m² of surface area for a thickness of 15 mm to 500 mm; still more preferably, from 0.3 m² to 15 m² of surface area for a thickness of 17 mm to 400 mm typically, from 0.35 m² to 7 m² of surface area for a thickness of 20 mm to 250 mm. Examples of dimensions are typically, a surface area of 600 mm*600 mm or 1,200 mm*600 mm for a thickness of 20 mm to 250 mm. By “block”, it should be understood a structure with any geometric, parallelepipedal cubic, star-like or cylindrical shape, with or without recess(es), with a volume comprised between 1 cm³ and 100 m³, preferably 10 cm³ to 70 m³, still more preferably 100 cm³ to 50 m³ typically 0.5 m³ to 35 m³, typically, from 1 m³ to 30 m³.

According to another aspect, a kit is provided for manufacturing a polyurethane foam comprising:
a mixture of alkoxylated polyphenols obtainable by the method according to the invention as defined hereinabove or a mixture of alkoxylated polyphenols according to the invention as defined hereinabove, and
a polyisocyanate compound.

The polyisocyanate compound is as described hereinbelow in connection with the method for manufacturing a polyurethane foam according to the invention.

More particularly, the polyisocyanate compound of the manufacturing kit may be selected from among toluene 2,4-diisocyanate, toluene 2,6-diisocyanate, hemimethylene 1,6-diisocyanate, diphenylmethane 4,4′-diisocyanate, a polyphenylisocyanate polymethylene, polymeric diphenylmethane diisocyanate, isophorone diisocyanate and mixtures thereof, in particular from among diphenylmethane 4,4′-diisocyanate, polymeric diphenylmethane diisocyanate, toluene 2,4-diisocyanate, toluene 2,6-diisocyanate and mixtures thereof.

### EXAMPLES

The following examples allow illustrating the invention yet without limiting it.

In these examples, the following are measured:
the hydroxyl value according to the standard ASTM 4274-99 wherein the colorimetric titration has been replaced by a pH-metric titration. More particularly, the measurement has been performed as follows. In a 250 ml single-necked round-bottomed flask, about 1 g of the sample are weighed with a 1 mg margin, 20 ml of a 1 N phthalic anhydride reactive solution in pyridine are added to the 20 ml volumetric pipette and then the system is refluxed for 45 min at 130° C. After having cooled the mixture, 10 ml of pyridine are introduced from the top of the refrigerant and then the content of the balloon is transferred into a top 150 ml beaker for titration. Afterwards, 20 ml of pyridine and 30 ml of water are added before titrating with potash in water at 1 N using the automatic titrator,
the viscosity at 25° C. with a TA Discovery HR-3 rheometer equipped with Peltier plates, with a 25 mm parallel plate geometry and shear rates ranging from 0.1 s⁻¹ to 100 s⁻¹,
the characteristic times of formation of the foam following the physical changes of the foam in expansion. The cream time corresponds to the start of the formation of bubbles causing a change in the colour of the mixture which becomes creamy. The processability time corresponds to the start of the formation of a stable network by intensive crosslinking and urethane formation reactions. The tack-free time corresponds to the time when the outer surface of the foam loses its adhesiveness,
the density according to the standard EN 1602 (September 2013),
the thermal conductivity using a heat flow meter HFM 446 according to the standard EN 12939 (March 2001), and
the fire resistance according to the standard EN 11925-2 (March 2020).

### Examples 1 to 4: Mixture of Alkoxylated Polyphenols Made from an Organosolv Lignin

Beechwood organosolv lignin produced by the Fabiola® process (supplied by Fraunhofer CBP (Leuna, Germany)) and poly(ethylene glycol) (denoted PEG, supplied by Acros Organics, CAS No. 25322-68-3) have been introduced into a 1 L reactor and then mixed. PEGs of different molar masses (g·mol⁻¹), different lignin contents and different PEG contents have been used. Afterwards, the lignin/PEG mixture is stirred using a mechanical stirrer and then ethylene carbonate (ethylene carbonate:lignin mass ratio of 1.1:1) and potassium carbonate (K₂CO₃) (K₂CO₃:ethylene carbonate molar ratio of 0.1:1) are successively added. Afterwards, the mixture is placed under an argon stream and immersed in an oil bath regulated at 130° C. for 4 h to manufacture a mixture of alkoxylated polyphenols.

The lignin and PEG contents (% by weight with respect to the total mass of the lignin/PEG mixture), the molar mass of the PEG, the hydroxyl value (IOH) and the viscosity of the mixtures of alkoxylated polyphenols are indicated in Table 1 hereinbelow.

### Example 5: Mixture of Alkoxylated Polyphenols Manufactured from a Kraft Lignin

The operating protocol is that of Examples 1 to 4, the differences being that the used lignin is a kraft lignin (Indulin AT®, Ingevity) and that one single poly(ethylene glycol) (PEG 300) with one single content is used.

The lignin and PEG contents (% by weight with respect to the total mass of the lignin/PEG mixture), the molar mass of the PEG, the hydroxyl value (IOH) and the viscosity of the manufactured mixture of alkoxylated polyphenols are indicated in Table 1 hereinbelow.

### Example 6: Mixture of Alkoxylated Polyphenols Manufactured from a Soda Lignin

The operating protocol is that of Examples 1 to 4, the differences being that the used lignin is a soda lignin (Protobind 1000, Green Value) and that one single poly(ethylene glycol) (PEG 300) with one single content is used.

The lignin and PEG contents (% by weight with respect to the total mass of the lignin/PEG mixture), the molar mass of the PEG, the hydroxyl value (IOH) and the viscosity of the manufactured mixture of alkoxylated polyphenols are indicated in Table 1 hereinbelow.

TABLE 1

| | Lignin | PEG | PEG molar | I_{OH} | Viscosity |
|---|---|---|---|---|---|
| Example | content | content | mass | (mg(KOH) · g⁻¹) | (Pa · s) |
| 1 | 25 | 75 | 150 (TEG) | 631 | 2.25 |
| 2 | 25 | 75 | 200 (PEG 200) | 493 | 3.25 |
| 3 | 25 | 75 | 300 (PEG 300) | 361 | 6.35 |
| 4 | 20 | 80 | 400 (PEG 400) | 305 | 2.98 |
| 5 | 25 | 75 | 300 (PEG 300) | 393 | 8.28 |
| 6 | 25 | 75 | 300 (PEG 300) | 379 | 6.60 |

The mixtures of alkoxylated polyphenols of Examples 1 to 6 have a hydroxyl value between 200 and 800 mg(KOH)·g⁻¹ and a viscosity between 2 and 10 Pa·s. Hence, they are suitable for the manufacture of polyurethane foam.

### Examples 7 to 10: Polyurethane Foam

The mixtures of alkoxylated polyphenols of Examples 1 to 4 are respectively used to manufacture a polyurethane foam according to Examples 7 to 10. For this purpose, a mixture of alkoxylated polyphenols is mixed with a conventional polyol (Daltolac® R570), a polyisocyanate compound (Desmodur® 44V70L) in the presence of a catalyst (Polycat® 8) and a mixture of additives (Tegostab® B1048 which is a surfactant, TCPP which is a flame retardant and isopentane which is a blowing agent). Afterwards, the properties of the manufactured foams are compared with a reference foam obtained from the conventional polyol alone. The composition by weight with respect to the total mass of polyols (conventional polyol alone or mixed with the mixture of alkoxylated polyphenols) and the properties of the different foams are indicated in Table 2.

Table 2 shows that the substitution of at least one part of the conventional polyol with the mixture of alkoxylated polyphenols allows reducing the amount of catalyst by at least 60% and even about 95%. In addition, the characteristic times of formation of the foams according to the invention, in particular the processability time and the tack-free time, are much less than the characteristic times of formation of the reference foam. This confirms that the mixture of alkoxylated polyphenols object of the present invention is very reactive.

Table 2 also shows that:
the densities of the foams according to the invention and of the reference foam are of the same order of magnitude
the thermal conductivities of the foams according to the invention and of the reference foam are of the same order of magnitude, and
the fire resistances of the foams according to the invention and of the reference foam are in accordance with the standard EN 11925-2.

Hence, the lignin-based foams according to the invention can be used in an insulating product. This allows valorising lignin.

TABLE 2

| | | 7 | | | 8 | | | 9 | | | 10 | | |
|---|---|---|---|---|---|---|---|---|---|---|---|---|---|
| Example | Reference | a) | b) | c) | a) | b) | c) | a) | b) | c) | a) | b) | c) |
| Composition | | | | | | | | | | | | | |
| Conventional polyol | 100 | 80 | 75 | 50 | 80 | 75 | 50 | 80 | 75 | 50 | 80 | 75 | 50 |
| Mixture of alkoxylated | 0 | 20 | 25 | 50 | 20 | 25 | 50 | 20 | 25 | 50 | 20 | 25 | 50 |
| polyphenols | | | | | | | | | | | | | |
| Polyisocyanate compound | 190 | 175 | 179 | 194 | 179 | 172 | 179 | 185 | 162 | 162 | 191 | 156 | 152 |
| Water | 1.6 | 1.6 | 1.6 | 1.6 | 1.6 | 1.6 | 1.6 | 1.6 | 1.6 | 1.6 | 1.6 | 1.6 | 1.6 |
| Catalyst | 2 | 0.72 | 0.53 | 0.11 | 0.72 | 0.53 | 0.2 | 0.79 | 0.50 | 0.17 | 0.80 | 0.50 | 0.23 |
| Surfactant | 2.5 | 2.5 | 2.5 | 2.5 | 2.5 | 2.5 | 2.5 | 2.5 | 2.5 | 2.5 | 2.5 | 2.5 | 2.5 |
| Flame retardant | 10 | 10 | 10 | 10 | 10 | 10 | 10 | 10 | 10 | 10 | 10 | 10 | 10 |
| Blowing agent | 17.4 | 13.9 | 16.0 | 16.5 | 14.1 | 15.8 | 14.8 | 14.7 | 15.1 | 13 | 15.1 | 14.9 | 12.3 |
| Properties | | | | | | | | | | | | | |
| Characteristic time (s) | 12 | 11 | 12 | 9 | 12 | 12 | 9 | 11 | 11 | 11 | 12 | 12 | 14 |
| cream | 46 | 37 | 37 | 23 | 38 | 34 | 23 | 35 | 30 | 30 | 41 | 38 | 40 |
| processability | | | | | | | | | | | | | |
| tack-free | 65 | 47 | 50 | 32 | 48 | 41 | 30 | 47 | 40 | 31 | 48 | 48 | 40 |
| Density (kg/m³) | 32.2 | 32.4 | 30.7 | n.d. | 31.5 | 31.0 | n.d. | 32.0 | 29.4 | n.d. | 31.4 | 29.8 | n.d. |
| Thermal conductivity | 23.5 | 24.2 | 25.5 | n.d. | 24.4 | 25.2 | n.d. | 24.3 | 25.4 | n.d. | 24.4 | 25.3 | n.d. |
| (mW m⁻¹ K⁻¹) | | | | | | | | | | | | | |
| Fire resistance | CF | CF | CF | n.d. | CF | CF | n.d. | CF | CF | n.d. | CF | CF | n.d. |

CF; In accordance with the standard EN 11925-2
n.d.: not determined

1-18. (canceled)

19. A method for manufacturing a mixture of alkoxylated polyphenols comprising the following step:
(a) bringing at least one polyphenol and a cyclic carbonate ester into contact in the presence of a solvent,
characterised in that
the solvent has a molar mass comprised between 150 g·mol⁻¹ and 600 g·mol⁻¹ and is selected from among a polyether, a polyester comprising OH groups at the end of the chain and mixtures thereof, and
the cyclic carbonate ester:polyphenol mass ratio is comprised between 0.3:1 and 5:1.

20. The method according to claim 19, wherein the polyphenol is selected from among a lignin, a condensed tannin, a hydrolysable tannin and mixtures thereof.

21. The method according to claim 19, wherein the cyclic carbonate ester is selected from among butylene carbonate, ethylene carbonate, propylene carbonate, glycerol carbonate and mixtures thereof.

22. The method according to claim 19, wherein the polyether is selected from among polybutylene glycol, polyethylene glycol, polypropylene glycol, polytrimethylene ether glycol, block copolymers, alternating or statistical obtained from these monomers and mixtures thereof.

23. The method according to claim 19, wherein the polyphenol:solvent mass ratio is comprised between 0.1:1 and 1:1.

24. The method according to claim 19, wherein a catalyst is implemented in step (a), said catalyst being a basic compound selected from among sodium hydroxide, sodium carbonate, sodium hydrogen carbonate, potassium hydroxide, potassium carbonate, potassium hydrogen carbonate, lithium hydroxide, calcium hydroxide, calcium carbonate, calcium hydrogen carbonate and mixtures thereof.

25. The method according to claim 24, characterised in that the catalyst:cyclic carbonate ester molar ratio is comprised between 0.001:1 and 0.5:1.

26. The method according to claim 24, wherein the polyphenol is a lignin, the cyclic carbonate ester is ethylene carbonate, the solvent is a polyethylene glycol with a molar mass comprised between 200 g·mol⁻¹ and 400 g·mol⁻¹ and the catalyst is potassium carbonate.

27. The method according to claim 25, wherein the polyphenol is a lignin, the cyclic carbonate ester is ethylene carbonate, the solvent is a polyethylene glycol with a molar mass comprised between 200 g·mol⁻¹ and 400 g·mol⁻¹ and the catalyst is potassium carbonate.

28. The method according to claim 19, wherein step (a) comprises the following sub-steps:
(a1) mixing the at least one polyphenol and the solvent to in a reactor obtain a mixture,
(a2) adding the cyclic carbonate ester into the mixture, and
(a3) optionally adding a catalyst into the mixture obtained in step (a2), and
(a4) mixing the mixture obtained in step (a2) or step (a3) to manufacture the alkoxylated polyphenol mixture.

29. The method according to claim 19, not comprising, after step (a), a step of purifying the mixture of alkoxylated polyphenols and/or a step of adding a viscosity adapter compound into the mixture of alkoxylated polyphenols.

30. A mixture of alkoxylated polyphenols obtainable by the method as defined in claim 19.

31. A method for manufacturing a polyurethane and/or polyisocyanurate material wherein a mixture of alkoxylated polyphenols produced in step (a) of the manufacturing method as defined in claim 19 or a mixture of alkoxylated polyphenols as defined in claim 12 is brought into contact with a polyisocyanate compound.

32. The method according to claim 31, wherein the polyisocyanate compound is selected from among m-phenylene diisocyanate, toluene 2,4-diisocyanate, toluene 2,6-diisocyanate, hexamethylene 1,6-diisocyanate, tetramethylene 1,4-diisocyanate, cyclohexane 1,4-diisocyanate, hexahydrotoluene diisocyanate, naphthylene 1,5-diisocyanate, methoxyphenyl-2,4-diisocyanate, diphenylmethane 4,4′-diisocyanate, biphenylene 4,4′-diisocyanate, 3,3′-dimethoxy-4,4′-biphenyl diisocyanate, 3,3′-dimethyl-4,4′-biphenyl diisocyanate, 3,3′-dimethyldiphenylmethane 4,4′-diisocyanate, 4,4′,4″-triphenyl methane triisocyanate, a polymethylene polyphenylisocyanate, polymeric diphenylmethane diisocyanate, isophorone diisocyanate, toluene 2,4,6-triisocyanate, 4,4′-dimethyldiphenylmethane-2,2′,5,5′-tetraisocyanate and mixtures thereof.

33. The method according to claim 31, wherein the polyurethane and/or polyisocyanurate material is a sealing product, an adhesive, a wood binder, a cast elastomer, a flexible or semi-flexible moulded part, a rigid structural composite, a polyurethane foam, a binder, a semi-flexible foam, a hose insulator, a cavity sealing module, or a microcellular foam.

34. The method according to claim 31, wherein the polyurethane and/or polyisocyanurate material is a polyurethane foam.

35. An acoustic and/or thermal insulating product comprising a foam obtainable by the method as defined according to claim 34.

36. A kit for manufacturing a polyurethane foam comprising:
a mixture of alkoxylated polyphenols obtainable by the method as defined according to claim 19 or a mixture of alkoxylated polyphenols as defined in claim 30, and
a polyisocyanate compound.

37. The method according to claim 19, wherein the solvent has a molar mass comprised between 175 g·mol⁻¹ and 600 g·mol⁻¹.
